(19) United States
(12) Patent Application Publication
(10) Pub. No.: US 2008/0305282 A1
(43) Pub. Date: Dec. 11, 2008

(54) Antireflection film and display front plate using the same

(75) Inventors: Tomoki Inakura, Osaka (JP); Noriaki Otani, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 12/155,373

(22) Filed: Jun. 3, 2008

(30) Foreign Application Priority Data
Jun. 6, 2007 (JP) 2007-150762
Dec. 25, 2007 (JP) 2007-332739

(51) Int. Cl. C09K 19/52

(52) U.S. Cl. 428/1.33

(57) ABSTRACT

An antireflection film including a polyester base 10 and an antireflection layer that is disposed on a side 10a of one principal surface of the polyester base 10 by the wet coating method. The antireflection layer includes, from a side of the polyester base 10, a hard coat layer 11 and a low-refractive index layer 12 that is disposed above the hard coat layer. The hard coat layer is provided directly on the polyester base 10, the hard coat layer contains a metal oxide, and the metal oxide is contained in a ratio of 20 vol % to 42 vol %. The present invention provides an antireflection film in which a primer layer for improving adhesion is not provided between a polyester base and a hard coat layer and the occurrence of interference fringes is suppressed, and that delivers excellent antireflection performance and exhibits high scratch resistance, and a display front plate using the antireflection film.

### BACKGROUND OF THE INVENTION

1. Field of the Invention

The present invention relates to an antireflection film including an antireflection layer and a display front plate using the same.

2. Description of Related Alt

In recent years, the development of high-definition and large-screen displays typified by a liquid crystal display and a plasma display panel (PDP) and the like has been advanced rapidly. In order to increase the visibility of the display surface of displays, it is required that an antireflection layer having an antireflection function be disposed on a surface of the display surface so that external light from a fluorescent lamp or the like is prevented from being reflected on the screen.

Known methods for forming the antireflection layer include a so-called dry coating method in which inorganic metal is vapor-deposited or sputtered on a display surface and a wet coating method in which a low-refractive index material or the like in a liquid form such as a solution or a dispersion solution is applied to a base, then is dried, and is hardened as required to produce a film or the like having an antireflection function. With the recent trend toward larger-size displays, the wet coating method that achieves a less costly production through a “roll-to-roll” process and is likely to be suited also for the production of larger-size displays has become mainstream. That is, now that the television industry or the like using high-definition and large-screen displays typified by a liquid crystal display, a plasma display panel (PDP) and the like has been experiencing a fierce price competition also in the international market, the method in which inorganic metal is vapor-deposited or sputtered is disadvantageous in that it exhibits poor productivity and leads to a cost increase. Though the wet coating method that achieves a less costly production and is likely to be suited also for the production of larger-size displays is becoming mainstream, there also has been a constant demand for a further reduction in the cost of an antireflection film produced by the wet coating method. Therefore, also in performing the wet coating method, when producing optical films of the same function such as, for example, antireflection films, it advantageously leads to a cost reduction if the antireflection films are such that the production thereof requires a reduced number of process steps, specifically, such that they can be produced with the number of layers to be formed and the number of processing steps reduced and have a required function and quality.

As an antireflection layer formed by the wet coating method, on a transparent base film, a hard coat layer for increasing the hardness of the base itself is provided, and on the hard coat layer, a single or plural layer(s) that vary in refractive index are formed in a thickness of around 100 nm each, thus constituting an antireflection film (see Patent Document 1).

Furthermore, as the transparent base film, a polyester resin film, particularly, a biaxially stretched film of polyethylene terephthalate (PET) is often used. A biaxially stretched PET film has transparency excellent mechanical properties, flame resistance or chemical resistance and the like and thus has been growing remarkably in demand as a base film for the above-described antireflection film.

However, generally speaking, such a polyester base hardly can retain excellent adhesion to an antireflection layer, and therefore, in most of the cases of using, for example, a biaxially stretched PET film as a transparent base, a primer layer for imparting an adhesion-improving property, which is referred to also as an adhesion-improving layer (referred to also as an anchor coat layer; hereinafter, a primer layer for imparting an adhesion-improving property is referred to as a “primer layer” for short unless otherwise specified) is provided on a surface of the PET film so that adhesion between the PET film and the antireflection layer is increased. That is, under the status quo of the production in practice, as described in, for example, paragraph [0032] of Patent Document 2, paragraphs [0077] to [0079] of Patent Document 3, paragraph [0024] of Patent Document 4, paragraph [0004] of Patent Document 5 and paragraph [0003] of Patent Document 6, which will be specified below, when forming an antireflection layer on a PET film by the wet coating method, a primer layer is formed as an adhesion-improving layer at least on the side of a principal surface of the PET film on which the antireflection layer is to be formed, or alternatively, a PET film on which a primer layer has been formed is used.

However, in an antireflection layer in which the relationship between the refractive index and film thickness of each layer provided on a base material is of great importance, a primer layer also has a considerable influence on the antireflection performance, and it therefore is required that in designing, consideration be given to the refractive indices and film thicknesses of three layers that are a base material, a primer layer and an antireflection layer (Patent Documents 2 to 4).

This way of optical designing, however, hardly can be achieved and is unlikely to suppress the occurrence of interference Singes. Further, providing a primer layer in addition to a hard coat layer and a low-refractive index layer requires an increased number of process steps, making it difficult to meet the market demand for a cost reduction.

As a method other than to provide a primer layer, it also has been proposed to subject a polyester base to an adhesion-improving surface pretreatment such as a corona discharge treatment or a plasma treatment (the “adhesion-improving surface pretreatment” is not a treatment in which a new layer such as a primer layer is formed separately but is a treatment intended to improve adhesion by modifying a surface of the base). However, sufficient adhesion hardly can be obtained by the corona discharge treatment or the plasma treatment alone (Patent Document 5).

Meanwhile, it has been proposed to use a particular type of resin for forming a hard coat layer so as to increase the adhesion to a polyester resin base material without a primer layer being provided (Patent Document 6). However, it hardly can be said that this method provides sufficient adhesion between the base and the hard coat layer.

[Patent Document 1] JP 2002-200690 A

[Patent Document 2] JP 2003-177209 A

[Patent Document 3] JP 2004-345333 A

[Patent Document 4] JP 2006-258897 A

[Patent Document 5] JP 2006-235125 A

[Patent Document 6] JP 2005-196065 A

### SUMMARY OF THE INVENTION

With the foregoing in mind, it is an object of the present invention to provide an antireflection film in which even when using a polyester base without a primer layer on the side of a principal surface thereof on which an antireflection layer is to be formed, good adhesion between the polyester base and the antireflection layer is secured, and the occurrence of interference fringes is prevented, so that excellent antireflection performance is obtained, as well as a display front plate using the antireflection film.

(1) In order to solve the aforementioned problems, an antireflection film according to the present invention is an antireflection film including a polyester base and an antireflection layer that is disposed on a side of one principal surface of the polyester base by a wet coating method,

wherein the antireflection layer includes, from a side of the polyester base, a hard coat layer and a low-refractive index layer that is disposed above the hard coat layer,

the hard coat layer is provided directly on the polyester base,

the hard coat layer contains a metal oxide, and

the metal oxide is contained in a ratio of 20 vol % to 42 vol %.

(2) Preferably, in the antireflection film described above in (1), the principal surface of the polyester base on the side on which the antireflection layer is disposed has not been subjected to an adhesion-improving surface pretreatment.

(3) Preferably, in the antireflection film described above in (1) or (2), the antireflection layer is such that no peeling of the antireflection layer from the polyester base is observed in a cross cut test performed based on JIS K 5600-5-6.

(4) Preferably, in the antireflection film described above in any one of (1) to (3), a maximum value of a difference in amplitude of a reflectance of the antireflection film at 380 nm to 780 nm is 1.0% or lower.

(5) Preferably, in the antireflection film described above in any one of (1) to (4), a near infrared ray absorption layer is disposed on a side of the other principal surface of the polyester base.

(6) Furthermore, a display front plate according to the present invention comprises a display front plate including a substrate and an antireflection film as described above in any one of (1) to (5) that is disposed on the substrate.

### Effects of the Invention

(1) According to the present invention, an antireflection film can be provided in which good adhesion between a polyester base and an antireflection layer can be secured, and moreover, the occurrence of interference fringes can be prevented, so that excellent antireflection performance is delivered. In addition, since the hard coat layer is provided directly on the polyester base without a primer layer for improving adhesion interposed therebetween, it is possible to provide an antireflection film that does not require the formation of a primer layer and thus is less costly. Besides, even without the above-described primer layer, adhesion between the polyester base and the antireflection layer can be secured.

(2) Furthermore, as a preferred embodiment according to the present invention, in the antireflection film described above in (1), the principal surface of the polyester base on the side on which the antireflection layer is disposed has not been subjected to an adhesion-improving surface pretreatment. According to this configuration, the adhesion between a polyester base and an antireflection layer can be secured even when the polyester base has not been subjected to an adhesion-improving surface pretreatment, and thus the adhesion-improving surface pretreatment may be skipped, thereby allowing an antireflection film to be provided at a cost reduced accordingly. (Claim 1 according to the present invention, however, is not intended to exclude the use of a polyester base that has been subjected to an adhesion-improving surface pretreatment.)

(3) Furthermore, as a preferred embodiment according to the present invention, in the antireflection film described above in (1) or (2), the antireflection layer is such that no peeling of the antireflection layer from the polyester base is observed in a cross cut test performed based on JIS K 5600-5-6. According to this configuration, an antireflection film of highly reliable quality can be provided in which the peeling of an antireflection layer does not occur.

(4) Furthermore, as a preferred embodiment according to the present invention, in the antireflection film described above in any one of (1) to (3), a maximum value of a difference in amplitude of a reflectance of the antireflection film at 380 nm to 780 nm is 1.0% or lower. According to this configuration, an antireflection film can be provided in which the occurrence of interference fringes is suppressed.

(5) Furthermore, as a preferred embodiment according to the present invention, in the antireflection film described above in any one of (1) to (4), a near infrared ray absorption layer is disposed on a side of the other principal surface of the polyester base. According to this configuration, when provided on a front surface of a plasma display panel (PDP) used as a display panel for various types of electronic equipment such as a large-sized television set and others, this antireflection film in which a near infrared ray absorption layer is provided further can function as a filter that blocks undesired-near infrared rays generated from the front surface of the PDP during use of the electronic equipment. Thus, an antireflection film can be provided that is suitable for preventing a problem that the leakage of said near infrared rays may cause a malfunction of peripheral electronic equipment such as, for example, a television set and an air conditioner and has an antireflection function.

(6) Furthermore, in the display front plate according to the present invention, an anti reflection film as described above in any one of (1) to (5) is disposed on a substrate, thereby allowing a less costly display front plate to be provided, and a display front plate to be provided in which an antireflection film exerts functions corresponding respectively to (1) to (5) above.

### BRIEF DESCRIPTION OF THE DRAWINGS

FIG. 1 is a cross-sectional view showing an example of an antireflection film according to the present invention.

FIG. 2 is a cross-sectional view showing another example of the antireflection film according to the present invention.

### DETAILED DESCRIPTION OF THE INVENTION

The polyester base used in the antireflection film according to the present invention has a light transmittance in the visible light region of preferably 80% or higher, and more preferably 88% or higher. The haze of the polyester base is preferably 2.0% or lower, and more preferably 1.0% or lower. Typical examples of a material for the polyester base include polyethylene terephthalate and polyethylene-2,6-naphthalenedicarboxylate, and as the polyester base, particularly, a biaxially stretched film of polyethylene terephthalate (PET) is used preferably since it is less costly and yet has combined functionality of transparency, excellent mechanical properties, flame resistance (flame retardancy), chemical resistance and the like. The above-described base normally has a thickness of about 10 to 500 μm. Additives such as an antioxidant, a flame retardant, a heat stabilizer, an ultraviolet absorbent, a lubricant and the like may be added to a resin constituting the above-described polyester base.

A coating material for forming the above-described hard coat layer may be obtained by adjusting combined materials of an ionizing radiation curing type resin, examples of which will be listed below, conductive and/or non-conductive metal oxide fine particles, a photopolymerization initiator, a solvent and the like, or alternatively, as the coating material, a mixture of these prepared and formed into an ink may be used. Using the below-described materials as components, a hard coat layer coating material could be prepared by performing a dispersion treatment in accordance with a general method for preparing a coating liquid.

It is required that in designing the refractive index of the hard coat layer, consideration be given to the relationship thereof with the refractive index of the base. For example, a PET base that is a polyester base has a refractive index of around 1.66. When a hard coat layer provided on the polyester base has a refractive index that differs greatly from the refractive index of the polyester base, interference fringes may occur. It normally is recognized that a refractive index difference between a hard coat layer and a base film of ±0.03 or more leads to the occurrence of interference fringes. It therefore is preferable that the above-described hard coat layer is set to have a refractive index of 1.60 to 1.70. The addition of a metal oxide having a large refractive index to a hard coat layer makes the hard coat layer have a refractive index approximating that of a base film. One or two or more types of metal oxides may be used in this case.

Furthermore, in the antireflection film according to the present invention, a maximum value of a difference in amplitude of a reflectance of the antireflection film at 380 nm to 780 nm is set to 1.0% or lower, and thus an antireflection film can be provided in which the occurrence of interference fringes is suppressed. To this end, as described above, it is preferable that a refractive index difference between a polyester base and a hard coat layer provided on the polyester base is set to less than ±0.03. In this case, since the refractive index of the polyester base hardly can be changed, normally, the refractive index of the hard coat layer is adjusted by selectively using materials constituting the hard coat layer, namely, an ionizing radiation curing type resin and metal oxide fine particles in combination, thereby allowing a maximum value of a difference in amplitude of a reflectance of a resulting antireflection film at 380 nm to 780 nm to be set to 1.0% or lower.

By the use of a conductive metal oxide as a metal oxide to be used in the hard coat layer, an antireflection film can be obtained that additionally delivers antistatic performance. When only one type of conductive metal oxide is used to attain a predetermined refractive index, the metal oxide content in the hard coat layer may become too high. Therefore, in this case, two or more types of metal oxides are used, so that an increased refractive index can be attained without the metal oxide content becoming too high.

Furthermore, the hard coat layer is formed using a resin containing an ionizing radiation curing type resin. This allows the hard coat layer to be formed efficiently.

As a metal oxide to be contained in the above-described hard coat layer, for example, antimony-doped tin oxide (ATO), indium-doped tin oxide (ITO), phosphorus-doped tin oxide (PTO), zinc oxide (ZnO), tin oxide (SnO), zirconium oxide (ZrO₂), or zinc antimonate (ZnSb₂O₆) can be used. This metal oxide in the form of fine particles may be used suitably. The fine particles have a mean particle diameter of preferably 100 nm or less, more preferably 50 nm or less, and particularly preferably 20 nm or less. This is because a mean particle diameter within these ranges provides improved dispersibility in an ionizing radiation curing type resin, thereby reducing the haze in a coating film that is formed. From the viewpoint of obtaining conductivity and a high refractive index, the lower limit of the mean particle diameter of the metal oxide preferably is 2.0 nm or more, though there is no particular limitation.

The mean particle diameter of these metal oxide particles is measured in the following manner. That is, an antireflection film containing metal oxide particles is cut using a microtome, a TEM (transmission electron microscope) photograph of a piece of the film cut in cross section is taken at 200,000× magnification, and a mean value of the respective diameters of 300 particles is used as a mean particle diameter. In the case where particles in the photograph that is taken are not round but have a major diameter and a minor diameter, and with respect to each particle, the major diameter and the minor diameter are measured, and a mean value of these measured values is calculated. With respect to each of 300 particles, this mean value is determined by measurement and calculation, and a mean value of the respective mean values of the 300 particles is used as a mean particle diameter.

In the present invention, it is crucial that the content ratio of a metal oxide in the hard coat layer should be 20 vol % to 42 vol %, and more preferably 25 to 35 vol %. This is because when the content ratio of a metal oxide in the hard coat layer is set to be in the above-described ranges, it is possible, without forming a primer layer on a principal surface of a polyester base on the side on which the hard coat layer is to be provided, to make the hard coat layer have adhesion to the principal surface of the polyester base that is strong enough for practical use as well as high strength as a coating film. When the ratio of a metal oxide contained in the hard coat layer is too small, presumably, the hard coat layer as a coating film volumetrically shrinks to a great extent and thus becomes likely to be peeled off from the polyester base. On the other hand, when the ratio of a metal oxide contained in the hard coat layer is too large, the strength of the hard coat layer as a coating film is lowered, and moreover, when the ratio is extremely large, it becomes difficult even to form a coating film. Therefore, the ratio of a metal oxide contained in the hard coat layer is set to be in the above-described ranges, and thus it is possible, without forming a primer layer, to make the hard coat layer have adhesion to the principal surface of the polyester base, which is strong enough for practical use. Further, a primer layer is not provided on the principal surface of the polyester base on the side on which the hard coat layer is to be provided, and thus the occurrence of interference fringes can be prevented, thereby allowing an antireflection film that delivers excellent antireflection performance to be provided.

The above-described ratio of a metal oxide refers to the volume of a metal oxide with respect to a total volume of the metal oxide and a resin solid content contained in the hard coat layer. The volume ratio can be determined by calculation based on the weight ratio between a metal oxide and a resin solid content and literature data of specific gravities of the materials.

As an ionizing radiation curing type resin used to form the above-described hard coat layer, a monomer having a vinyl group, a (meth)acryloyl group, an epoxy group, or an oxetanyl group, a prepolymer thereof, or a polymer thereof can be used. These can be used alone or in combination of two or more types. From the viewpoint of achieving both good productivity and good hardness, it is preferable to use a multifunctional monomer or oligomer. As a multifunctional monomer or oligomer, a multifunctional acrylic monomer having two or more unsaturated groups or an oligomer thereof is used preferably. Moreover, the use of a monomer or oligomer having many binding groups or functional groups that form hydrogen bonds in molecules thereof improves adhesion to a polyester base. Further, the use of a monomer or oligomer having a high refractive index such as bisphenol A modified (meth)acrylate allows the hard coat layer to have an increased refractive index.

Examples of a multifunctional acrylic monomer or oligomer include esters derived from a polyhydric alcohol and a (meth)acrylic acid such as ethyleneglycol di(meth)acrylate, diethyleneglycol di(meth)acrylate, triethyleneglycol di(meth)acrylate, 1,4-cyclohexane diacrylate, pentaerythbitol tetra(meth)acrylate, pentaerythritol tri(meth)acrylate, trimethylolpropane tri(meth)acrylate, trimethylolethane tri(meth)acrylate dipentaerythritol tetra(meth)acrylate, dipentaerythritol penta(meth)acrylate, dipentaerythritol hexa(meth)acrylate, 1,2,3-cyclohexane trimethacrylate, polyurethanepolyacrylate, and polyesterpolyacrylate; vinylbenzenes such as 1,4-divinylbenzene, 4-vinylbenzoic acid-2-acryloylethyl ester, and 1,4-divinyl cyclohexanone; and derivatives thereof. These may be used alone or in combination of two or more types. From the viewpoint of enhancing the abrasion resistance, among these, at least one selected from pentaerythritol triacrylate and dipentaerythritol hexaacrylate is used preferably. As for pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, and dipentaerythritol hexa(meth)acrylate, these are used preferably from the viewpoint of increasing the film strength. Herein, “ . . . (meth)acrylate . . . ” refers to “ . . . acrylate . . . ” and/or “ . . . methacrylate . . . . ”

In the case where ultraviolet irradiation is performed to cure an ionizing radiation curing type resin contained in the above-described hard coat layer, a photopolymerization initiator is added to an application liquid for forming the hard coat layer. As a photopolymerization initiator, acetophenones, benzophenones, ketals, anthraquinones, thioxanthones, azo compounds, peroxides, 2,3-dialkyldione compounds, disulphide compounds, thiuram compounds, fluoro amine compounds, or the like are used. These can be used alone or in combination of two or more types. It normally is preferable to use a photopolymerization initiator in an amount of about 1 to 15 mass % with respect to the mass of an ionizing radiation curing type resin that is used.

As other components of a composition of the above-described hard coat layer, additives such as a polymerization-inhibitor, an antioxidant, a dispersant, a surface-active agent, a photostabilizer, and a leveling agent may be added. Further, a solvent can be added in any amount as long as a film is formed by the wet coating method and then is dried.

There is no particular limitation on a method for forming the hard coat layer on a polyester base, and it is possible to form the hard coat layer by applying an application liquid containing the above-described materials onto the polyester base. There also is no particular limitation on an application method, and, for example, it is possible to use a coating method such as roll coating, die coating, airknife coating, blade coating, spin coating, reverse coating, or gravure coating; or a printing method such as gravure printing, screen printing, offset printing, or inkjet printing.

The above-described hard coating layer has a surface hardness of preferably H or more, and more preferably 2H or more, based on the evaluation according to the pencil hardness test stipulated in JIS K 5600.

Furthermore, the hard coat layer has a thickness of preferably 0.3 to 3.0 μm, more preferably 0.3 to 2.0 μm, and still more preferably 0.3 to 1.5 μm.

With the hard coat layer having a thickness of less than 0.3 μm, it becomes unlikely that the hard coat layer maintains its hardness. Further, with the hard coat layer having a thickness of more than 3.0 μm, it becomes likely that a crack or curl (warp of a film) occurs or the total light transmittance of an antireflection film is lowered, and it further becomes likely that an ionizing radiation curing type resin volumetrically shrinks to a greater extent and thus the hard coat layer is peeled off from a polyester base. Therefore, the hard coat layer preferably has a thickness in the above-described ranges.

With respect to the low-refractive index layer that is disposed on the above-described hard coating layer; an optical film thickness that is a product of a refractive index and a film thickness is set to be in the vicinity of λ/4 (λ: a wavelength of light visible to the human eye. Particularly, it is often set to 550 nm that is a wavelength of light with respect to which the human eye has a high luminosity factor). This further lowers the reflectance and thus is more preferable.

Furthermore, the larger the refractive index difference between the low-refractive index layer and the hard coat layer, the more the antireflection property improves. Moreover, in the case where the low-refractive index layer is positioned on an uppermost surface of the antireflection film according to this embodiment (i.e. in the case where no other functional layer further is provided on the low-refractive index layer), the low-refractive index layer preferably has strength and an antifouling property, and from these viewpoints, it preferably contains a resin having a perfluoro group and a polydimethylsiloxane moiety.

A coating material for forming the above-described low-refractive index layer may be obtained by adjusting combined materials of a material for forming a binder resin, examples of which will be listed below, fine particles with a low refractive index, a photopolymerization initiator, a solvent and the like, or alternatively, as the coating material, a mixture of these prepared and formed into an ink may be used. Using the below-described materials as components, a low-refractive index coating material could be prepared by performing a dispersion treatment in accordance with a general method for preparing a coating liquid.

As materials used to form the above-described low-refractive index layer, known materials in general use for forming a low-refractive index layer may be used. For example, it is possible to use a coating liquid containing inorganic fine particles with a low refractive index of porous silica, magnesium fluoride or the like and a material for forming a binder resin, or a coating liquid containing a fluorocarbon resin and the like.

As a material for forming a binder resin that is used to form the above-described low-refractive index layer, an ionizing radiation curing type resin made of a monomer having a vinyl group, a (meth)acryloyl group, an epoxy group, or an oxetanyl group, a prepolymer thereof, or a polymer thereof can be used. Herein, a “(meth)acryloyl group” refers to an “acryloyl group” and/or a “methacryloyl group.” Further, in the case of using a thermosetting binder, an inorganic binder may be used. Examples of an inorganic binder include silica sol. Examples of silica sol include silica sol using silicon alkoxide and an acid catalyst or alkali catalyst as starting materials. As silicon alkoxide, for example, tetramethoxysilane or tetraethoxysilane is used.

In the case where ultraviolet irradiation is performed to cure an ionizing radiation curing type resin contained in the above-described low-refractive index layer, a photopolymerization initiator is added to an application liquid for forming the low-refractive index layer. As a photopolymerization initiator, acetophenones, benzophenones, ketals, anthraquinones, thioxanthones, azo compounds, peroxides, 2,3-dialkyldione compounds, disulphide compounds, thiuram compounds, fluoro amine compounds, or the like are used. These can be used alone or in combination of two or more types. It normally is preferable to use a photopolymerization initiator in an amount of about 1 to 15 mass % with respect to the mass of an ionizing radiation curing type resin that is used.

As other components of a composition of the above-described low-refractive index layer, additives such as a polymerization-inhibitor, an antioxidant, a dispersant, a surface-active agent, a photostabilizer, and a leveling agent may be added. Further, a solvent can be added in any amount as long as a film is formed by the wet coating method and then is dried.

There is no particular limitation on a method for forming the low-refractive index layer on a hard coat layer, and similarly to the above-described case of forming the hard coat layer, it is possible to form the low-refractive index layer by applying an application liquid containing the above-described materials onto the hard coat layer.

Furthermore, in the antireflection film according to the present invention, a near infrared absorption layer further can be disposed on the side of the other principal surface of the above-described transparent polyester base. According to this configuration, when the antireflection film according to this embodiment is disposed on a surface of a PDP, undesired near infrared rays emitted during plasma discharge are blocked and thus do not adversely affect peripheral equipment using electronic components, which particularly can solve a problem whereby remote controllers of a television set, an air conditioner and the like are caused to malfunction.

There is no particular limitation on a material for the above-described near infrared absorption layer as long as the material is a translucent material that absorbs near infrared rays, and normally, a resin is used in which a compound that absorbs near infrared rays is dispersed.

The above-described compound that absorbs near infrared rays preferably is a compound having a maximum absorption wavelength in a wavelength region of 850 to 1,100 nm. If the near infrared absorption layer contains the above-described compound, it is possible to reduce the transmission with respect to near infrared rays in the wavelength region of 850 to 1,100 nm without significantly reducing the transmittance with respect to visible light of a wavelength of 400 to 850 nm. This allows the antireflection film according to this embodiment to be used suitably also as a near infrared absorption filter for a PDP or the like.

As the above-described compound having a maximum absorption wavelength in the wavelength region of 850 to 1,100 nm, for example, aminium-based, azo-based, azine-based, anthraquinone-based, indigoid-based, oxazine-based, quinophthalonine-based, squarylium-based, stilbene-based, triphenylmethane-based, naphthoquinone-based, diimonium-based, phthalocyanine-based, cyanine-based, or polymethine-based organic dye can be used.

As the above-described resin in which the compound that absorbs near infrared rays is to be dispersed, a polyester resin, an acrylic resin, a polyurethane resin, a polyvinyl chloride resin, an epoxy resin, a polyvinyl acetate resin, a polystyrene resin, a cellulose resin, a polybutyral resin or the like can be used, and these resins can be used in combination of two or more types as a polymer blend.

There is no particular limitation on a method for forming the near infrared absorption layer on a polyester base, and similarly to the above-described case of forming the hard coat layer, it is possible to form the near infrared absorption layer by applying an application liquid containing the above-described materials on the base. The near infrared absorption layer has a thickness of preferably 1 to 10 μm, and more preferably 2 to 7 μm. With the near infrared absorption layer having a thickness of less than 1 μm, it becomes likely that near infrared rays hardly can be absorbed. Further, with the near infrared absorption layer having a thickness of more than 10 μm, it becomes likely that a crack or curl (warp of a film) occurs. Therefore, the near infrared absorption layer preferably has a thickness in the above-described ranges.

A compound that cuts off a neon bright-line spectrum (orange color) of a PDP also can be added to the near infrared absorption layer as appropriate. This allows a red color to be developed more vividly on a P DP. As the compound that cuts off a neon bright-line spectrum, organic dye having a maximum absorption wavelength in a wavelength region of 580 to 620 nm can be used, and examples thereof include cyanine-based, azlenium-based, squarylium-based, diphenylmethane-based, triphenylmethane-based, oxazine-based, azine-based, thiopyrylium-based, viologen-based, azo-based, azo metal complex salt-based, azaporphyrin-based, bisazo-based, anthraquinone-based, and phthalocyanine-based organic dye.

The thickness of the above-described near infrared absorption layer, the types of materials therefor, the content ratios of the materials, and the like could be determined as appropriate so that the spectral transmittance of the antireflection film is 20% or lower throughout a wavelength range of 850 to 1,100 nm. There is no harm in providing a primer layer for improving adhesion in advance on a principal surface of a polyester base on the side on which the near infrared absorption layer is to be provided, and it normally is preferable that a primer layer is provided in advance. Further, as required, the principal surface of the polyester base on the side on which the near infrared absorption layer is to be provided may have been subjected to an adhesion-improving treatment such as a corona discharge treatment or a plasma treatment.

By referring to the appended drawing, the present invention will be described in the following in which the descriptions that already have been made in the above-described embodiments may not be repeated

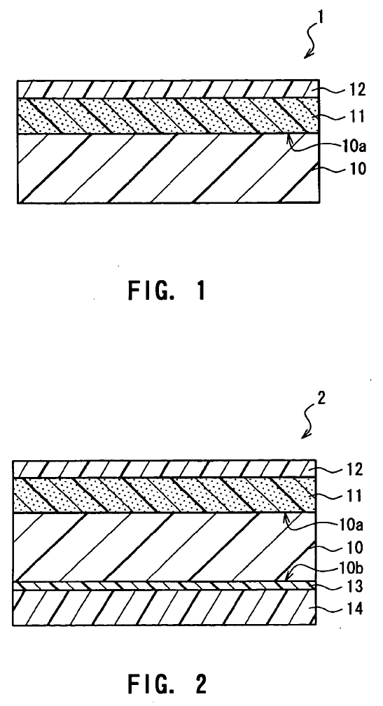

FIG. 1 is a cross-sectional view showing an example of the antireflection film according to the present invention. In FIG. 1, an antireflection film 1 includes a polyester base 10, a hard coat layer 11 that is provided directly on one principal surface 10a of the polyester base 10 without an intermediate layer such as a primer layer for improving adhesion interposed between the polyester base 10 and the hard coat layer 11, and a low-refractive index layer 12 that is provided on the hard coat layer 11. The hard coat layer 11 and the low-refractive index layer 12 constitute an antireflection layer.

FIG. 2 is a cross-sectional view showing another example of the antireflection film according to the present invention. An antireflection film 2 shown in FIG. 2 is the same as the antireflection film in FIG. 1 except that a near infrared absorption layer 14 is provided on the other principal surface 10b of a polyester base 10 with a primer layer 13 interposed between the polyester base 10 and the near infrared absorption layer 14, and therefore, the same reference numerals are used to indicate the same portions as in the antireflection film in FIG. 1, duplicate descriptions of which thus are omitted.

In the present invention, though it is required that a hard coat layer be provided directly-on the polyester base without a primer layer for improving adhesion interposed therebetween, on the side of a principal surface of the polyester base opposite the side on which the hard coat layer is to be provided, as shown in, for example, FIG. 2, a primer layer for improving adhesion may be provided as required. In the present invention, that “the hard coat layer is provided directly on the polyester base” means not only that a primer layer for improving adhesion is not provided but also that there also is no other layer provided between the hard coat layer and the polyester base.

Though it is essential that a hard coat layer be provided directly on the polyester base, it is optional to provide, as required, other appropriate functional layers such as an antistatic layer, a high-refractive index layer, and an antifouling layer between the hard coat layer and a low-refractive index layer or on the low-refractive index layer as long as that does not hamper the achievement of the object of the present invention. There is no harm in providing, as required, the near infrared absorption layer shown in FIG. 2 and other appropriate functional layers such as a pressure-sensitive adhesive layer and an electromagnetic wave blocking layer on the side of a principal surface of the polyester base opposite the side on which the hard coat layer is to be provided as long as that does not hamper the achievement of the object of the present invention.

For use, the above-described antireflection film according to the present invention is provided on a front plate of, for example, a plasma display panel (PDP) or a liquid crystal display that is used as a display panel for various types of electronic equipment such as a large-sized television set and others. In that case, the antireflection film is used so that a principal surface thereof on the side opposite an antireflection layer is on a display side.

Furthermore, the display front plate according to the present invention includes a substrate and the antireflection film according to the present invention that is disposed on the substrate.

There is no particular limitation on the substrate of the display front plate according to the present invention as long as it is optically transparent and strong enough for the protection of a display, and as the substrate, for example, a glass base or a plastic base is used.

The thickness of the substrate may vary depending on the type of display and a material for the substrate and also is not limited particularly. Normally, a substrate having a thickness of 0.2 to 20 mm and preferably 0.2 to 15 mm is used.

In allowing the antireflection film according to the present invention to adhere to a substrate, the antireflection film could be bonded onto the substrate as appropriate with an adhesive or a pressure-sensitive adhesive. Also in this case, similarly to the above, the antireflection film according to the present invention is bonded to the substrate so that a principal surface thereof on the side opposite an antireflection layer is on a substrate side of a display front plate.

According to the display front plate of the present invention, a display front plate can be provided that is applied to a front surface side of a display surface of a display such as a liquid crystal display or a plasma display panel (PDP) and can perform, depending on the types of layers constituting the antireflection film that are used, an antireflection function and a function as a filter that blocks near infrared rays.

### EXAMPLES

Hereinafter, the present invention will be described by way of examples, though not limited to the Examples below. In the following, a “part” in the Examples and Comparative Examples refers to a part by weight. The volume content ratio was determined by calculation based on the weight ratio between a metal oxide and a resin solid content and literature data of specific gravities of materials.

### Example 1

An antireflection film for evaluation having the same structure as that of the antireflection film shown in FIG. 2 was manufactured in the following manner.

As a polyester base, a polyethylene terephthalate (PET) film having a property of cutting off ultraviolet rays and a thickness of 100 μm (total light transmittance: 92.0%, refractive index: 1.66) was prepared, to which an ultraviolet absorbent had been added. Only on one surface of the polyethylene terephthalate film, a silica-containing primer layer made of an acrylic resin had been formed.

### Then,

5.5 parts of antimony-doped tin oxide fine particles (produced by Mitsubishi Materials Corporation, mean particle diameter: 20 nm),
4.5 parts of zirconium oxide fine particles (produced by Daiichi Kigenso Kagaku Kogyo Co., Ltd, mean particle diameter: 10 nm),
1.0 part of “Disperbyk-180” (dispersant produced by BYK-Chemie GmbH),
5.0 parts of acetylacetone,
30 parts of propyleneglycolmonomethylether, and
zirconia beads having a diameter of 0.3 mm were put into a vessel and dispersed for 3 hours with a paint shaker, after which the zirconia beads were removed, and thus a dispersion solution having an ATO/ZrO₂ weight ratio of 55:45 was manufactured.

To this dispersion solution,

2 parts of pentaerythritol triacrylate,
2.7 parts of dipentaerythritol hexaacrylate, and
0.3 parts of “Irgacure907” (photopolymerization initiator produced by Ciba Specialty Chemicals Corporation)
were added so that a coating material for forming a hard coat layer (hereinafter, referred to simply as a coating material for a hard coat layer) was prepared.

On the side of a surface of the above-described translucent PET film with the primer layer, on which the primer layer was not provided, this coating material for a hard coat layer was applied with a micro-gravure coater (produced by Yasui Seiki Company Ltd.) and then was dried. Subsequently, a resulting coating film was irradiated with ultraviolet rays in a dose of 500 mJ/cm² so as to be cured, and thus a hard coat layer having a thickness of 1.5 μm was formed (ratio of a metal oxide in the coating film: 29-vol %, refractive index of the coating film: 1.64).

After that, on the above-described hard coat layer, an ionizing radiation curing type low-refractive index coating material in which hollow silica fine particles had been dispersed (“ELCOM P-5013” produced by Catalysts & Chemicals Ind. Co., Ltd.) was applied with a micro-gravure coater and was dried. Then, a resulting coating film was irradiated with ultraviolet rays in a dose of 800 mJ/cm² so as to be cured, and thus a. low-refractive index layer having a thickness of 107 nm was formed.

### <Manufacture of Coating Material for Near Infrared Absorption Layer>

A coating material for a near infrared ray absorption layer was manufactured by mixing and agitating the following materials.

(1) Acrylic resin “DIANAL” (produced by Mitsubishi Rayon Co., Ltd.): 100 parts
(2) Aromatic diimonium dye “CIR-1085” (produced by Japan Carlit Co., Ltd.): 6 parts
(3) Near infrared absorbing compound containing a cyanine moiety and a dithiol metal complex moiety “SD50-E04N” (produced by Sumitomo Seika Chemicals Co., Ltd., maximum absorption wavelength: 877 nm): 1 part
(4) Near infrared absorbing compound containing a cyanine moiety and a dithiol metal complex moiety “SD50-E05N” (produced by Sumitomo Seika Chemicals Co. Ltd., maximum absorption wavelength: 833 nm): 1 part
(5) Methyl ethyl ketone: 125 parts
(6) Toluene: 460 parts

Next, using the above-described micro-gravure coater, the above-described coating material for a near infrared absorption layer was applied onto the primer layer of the above-described PET base so that a near infrared absorption layer was formed in a thickness of 4 μm, and thus an antireflection film for evaluation was manufactured.

### Example 2

In this example,
6 parts of antimony-doped tin oxide fine particles (produced by Mitsubishi Materials Corporation, mean particle diameter: 20 nm),
4 parts of zirconium oxide fine particles (produced by Daiichi Kigenso Kagaku Kogyo Co., Ltd., mean particle diameter: 10 nm),
1.0 part of “Disperbyk-180” (dispersant produced by BYK-Chemie GmbH),
5.0 parts of acetylacetone,
30 parts of propyleneglycolmonomethylether, and
zirconia beads having a diameter of 0.3 mm were put into a vessel and dispersed for 3 hours with a paint shaker, after which the zirconia beads were removed, and thus a dispersion solution having an ATO/ZrO₂ weight ratio of 60:40 was manufactured and used for adjustment.

To this dispersion solution,

1.7 parts of pentaerythritol triacrylate,
1.6 parts of dipentaerythritol hexaacrylate, and
0.3 parts of “Irgacure907” (photopolymerization initiator produced by Ciba Specialty Chemicals Corporation)
were added so that a coating material for a hard coat layer was prepared.

In the same manner as in the case of Example 1 except that this coating material for a hard coat layer was used, an antireflection layer and a near infrared absorption layer were formed, and thus an antireflection film for evaluation was manufactured (ratio of a metal oxide in a hard coat layer: 36 vol %, refractive index of the hard coat layer: 1.68).

### Example 3

In this example,
4.5 parts of antimony-doped tin oxide fine particles (produced by Mitsubishi Materials Corporation, mean particle diameter: 20 nm),
5.5 parts of zirconium oxide fine particles (produced by Daiichi Kigenso Kagaku Kogyo Co., Ltd., mean particle diameter: 10 nm),
1.0 part of “Disperbyk-180” (dispersant produced by BYK-Chemie GmbH),
5.0 parts of acetylacetone,
30 parts of propyleneglycolmonomethylether, and
   zirconia beads having a diameter of 0.3 mm were put into a vessel and dispersed for 3 hours with a paint shaker, after which the zirconia beads were removed, and thus a dispersion solution having an ATO/ZrO₂ weight ratio of 45:55 was manufactured and used for adjustment.

To this dispersion solution,

3 parts of pentaerythritol triacrylate,
3 parts of dipentaerythritol hexaacrylate, and
0.5 parts of “Irgacure907” (photopolymerization initiator produced by Ciba Specialty Chemicals Corporation)
were added so that a coating material for a hard coat layer was prepared.

In the same manner as in the case of Example 1 except that this coating material for a hard coat layer was used, an antireflection layer and a near infrared absorption layer were formed, and thus an antireflection film for evaluation was manufactured (ratio of a metal oxide in a hard coat layer: 24 vol %, refractive index of the hard coat layer: 1.63).

### Example 4

In this example,
6 parts of antimony-doped tin oxide fine particles (produced by Mitsubishi Materials Corporation, mean particle diameter: 20 nm),
4 parts of zirconium oxide fine particles (produced by Daiichi Kigenso Kagaku Kogyo Co., Ltd., mean particle diameter: 10 nm),
1.0 part of “Disperbyk-180” (dispersant produced by BYK-Chemie GmbH),
5.0 parts of acetylacetone,
30 parts of propyleneglycolmonomethylether, and
zirconia beads having a diameter of 0.3 mm were put into a vessel and
dispersed for 3 hours with a paint shaker, after which the zirconia beads were removed, and thus a dispersion solution having an ATO/ZrO₂ weight ratio of 60:40 was manufactured and used for adjustment.

It this dispersion solution,

1.9 parts of pentaerythritol triacrylate,
1.9 parts of dipentaerythritol hexaacrylate, and
0.3 parts of “Irgacure907” (photopolymerization initiator produced by Ciba Specialty Chemicals Corporation)
were added so that a coating material for a hard coat layer was prepared.

In the same manner as in the case of Example 1 except that this coating material for a hard coat layer was used, an antireflection layer and a near infrared absorption layer were formed, and thus an antireflection film for evaluation was manufactured (ratio of a metal oxide in a hard coat layer: 31 vol %, refractive index of the hard coat layer: 1.66).

### Comparative Example 1

In this example,
6.5 parts of antimony-doped tin oxide fine particles (produced by Mitsubishi Materials Corporation, mean particle diameter: 20 nm),
3.5 parts of zirconium oxide fine particles (produced by Daiichi Kigenso Kagaku Kogyo Co., Ltd., mean particle diameter: 10 nm),
1.0 part of “Disperbyk-180” (dispersant produced by BYK-Chemie GmbH),
5.0 parts of acetylacetone,
30 parts of propyleneglycolmonomethylether, and
zirconia beads having a diameter of 0.3 mm were put into a vessel and dispersed for 3 hours with a paint shaker, after which the zirconia beads were removed, and thus a dispersion solution having an ATO/ZrO₂ weight ratio of 65:35 was manufactured and used for adjustment

To this dispersion solution,

5 parts of pentaerythritol triacrylate,
5 parts of dipentaerythritol hexaacrylate,
0.7 parts of “Irgacure907” (photopolymerization initiator produced by Ciba Specialty Chemicals Corporation), and
13 parts of propyleneglycolmonomethylether
were added so that a coating material for a hard coat layer was prepared.

In the same manner as in the case of Example 1 except that this coating material for a hard coat layer was used, an antireflection layer and a near infrared absorption layer were formed, and thus an antireflection film for evaluation was manufactured (ratio of a metal oxide in a hard coat layer: 16 vol %, refractive index of the hard coat layer: 1.59).

### Comparative Example 2

In this example, as a base, a polyethylene terephthalate (PET) film having a property of cutting off ultraviolet rays and a thickness of 100 μm (total light transmittance: 92.1%) was used. On each of both surfaces of the polyethylene terephthalate film, a primer layer (refractive index: 1.58) made of a silica-containing polyester resin had been formed. Except for this, in the same manner as in the case of Example 1, an antireflection layer and a near infrared absorption layer were formed, and thus an antireflection film for evaluation was manufactured.

### Comparative Example 3

In this example,
10 parts of antimony-doped tin oxide fine particles (produced by Mitsubishi Materials Corporation, mean particle diameter: 20 nm),
1.0 part of “Disperbyk-180” (dispersant produced by BYK-Chemie GmbH),
5.0 parts of acetylacetone,
30 parts of propyleneglycolmonomethylether, and
zirconia beads having a diameter of 0.3 mm were put into a vessel and dispersed for 3 hours with a paint shaker, after which the zirconia beads were removed, and thus an ATO dispersion solution was manufactured and used for adjustment

To this dispersion solution,

1.1 parts of pentaerythritol triacrylate,
1.1 parts of dipentaerythritol hexaacrylate, and
0.15 parts of “Irgacure907” (photopolymerization initiator produced by Ciba Specialty Chemicals Corporation)
were added so that a coating material for a hard coat layer was prepared. In the same manner as in the case of Example 1 except that this coating material for a hard coat layer was used, an antireflection layer and a near infrared absorption layer were formed, and thus an antireflection film for evaluation was manufactured (ratio of a metal oxide in a hard coat layer: 45 vol %, refractive index of the hard coat layer: 1.69).

The properties of the antireflection films according to Examples 1 to 4 and Comparative Examples 1 to 3 above were evaluated in the following manner.

### <Refractive Index>

With respect to each of the antireflection films for evaluation, the refractive index of the hard coat layer was measured with a refractive index measuring device “FilmTek3000” (produced by SCl).

### <Pencil Hardness Test>

With respect to each of the antireflection films for evaluation, the pencil hardness of the hard coat layer was measured based on JIS K 5600-5-4:1999.

### <Adherability (Cross Cut Test)>

In conformance with JIS K 5600-5-6: 1999, an adherability (cross cut method) test was performed in order to evaluate the adhesion between the PET base and the antireflection layer (by a cross cut process, incisions were made so that a pattern of 100 squares (grid) was created). Table 1 shows results thereof in which, specifically, each case in which no peeling from the 100 squares occurred is denoted as X and each of the other cases is denoted as Y.

### <Reflectance—Luminous Reflectance>

With respect to each of the antireflection films, a surface thereof on the side opposite the side of the antireflection layer was sanded with sandpaper, and then the sanded surface was painted black using an oil-based felt-tipped pen. Then, the luminous reflectance thereof was measured with a spectrophotometer “Mest V-570 type” (produced by JASCO Corporation).

<Transmittance with Respect to Near Infrared Rays>

Using the above-described spectrophotometer, with respect to each of the antireflection films after the near infrared absorption layer had been provided therein, with the near infrared absorption layer side being set to be an incident light side, a maximum value of a transmittance in the near infrared wavelength region of 850 to 1,100 nm was measured. As a result, all of the antireflection films for evaluation according to Examples 1 to 4 and Comparative Examples 1 to 3 had a value of a transmittance with respect to near infrared rays of 12% or lower.

### <Haze>

A measurement of haze was performed with a haze meter produced by Nippon Denshoku Industries Co., Ltd

### <Surface Resistance Value>

Using a high surface resistivity meter “Hiresta HT-20” (produced by Mitsubishi Petrochemical Co., Ltd.), with respect to each of the antireflection films for evaluation after the near infrared absorption layer had been provided therein, a surface resistance value on the side thereof on which the low-refractive index layer was provided was measured.

Table 1 shows results of the above-described measurements except for the respective values of a transmittance with respect to near infrared rays.

TABLE 1

| | | | | | Com. | Com. | Com. |
|---|---|---|---|---|---|---|---|
| | Ex. 1 | Ex. 2 | Ex. 3 | Ex. 4 | Ex. 1 | Ex. 2 | Ex. 3 |
| Metal oxide (vol %) | 29 | 36 | 24 | 31 | 16 | 29 | 45 |
| Primer layer | Not | Not | Not | Not | Not | Present | Not |
| | present | present | present | present | present | | present |
| Haze (%) | 0.4 | 0.7 | 0.4 | 0.4 | 0.3 | 0.4 | 1.7 |
| Luminous | 0.83 | 0.61 | 0.88 | 0.85 | 1.11 | 1.3 | 0.56 |
| reflectance (%) | | | | | | | |
| Maximum value of | 0.19 | 0.14 | 0.31 | 0.08 | 1.05 | 1.64 | 0.25 |
| difference in | | | | | | | |
| amplitude of | | | | | | | |
| reflectance at | | | | | | | |
| 380 nm to 780 nm | | | | | | | |
| (%) | | | | | | | |
| Adhesion | X | X | X | X | Y | X | Y |
| Pencil hardness | 2H | H | 2H | H | 2H | 2H | B |
| Surface electrical | 1 × 10¹⁰ | 6 × 10⁹ | 8 × 10¹¹ | 1 × 10¹⁰ | 2 × 10¹¹ | 2 × 10¹⁰ | 3 × 10⁸ |
| resistance value | | | | | | | |
| (Ω/square) | | | | | | | |

As is apparent from Table 1, it is understood that compared with the antireflection films according to Comparative Examples 1 to 3 that do not meet the constituent features recited in claim 1, each of the antireflection films according to Examples 1 to 4 has higher hardness, more excellent adhesion, and a lower value as a maximum value of a difference in amplitude of a reflectance at 380 nm to 780 nm.

The present invention may be embodied in other forms without departing from the gist-thereof. The embodiments disclosed in this application are to be considered in all respects as illustrative and not limiting. The scope of the present invention is indicated by the appended-claims rather than by the foregoing description, and all changes which come within the meaning and range of equivalency of the claims are intended to be embraced therein.

### INDUSTRIAL APPLICABILITY

As described in the foregoing discussion, the present invention can provide an anti reflection film including an antireflection layer that suppresses the occurrence of interference fringes, delivers excellent antireflection performance, and further exhibits high scratch resistance. Through the use of the antireflection film according to the present invention or a display front plate using the antireflection film, a front filter can be provided that is suitable for use in various displays, particularly in a PDP.

What is claimed is:

1. An antireflection film, comprising:
a polyester base; and
an antireflection layer that is disposed on a side of one principal surface of the polyester base by a wet coating method,
wherein the antireflection layer includes, from a side of the polyester base:
a hard coat layer; and
a low-refractive index layer that is disposed above the hard coat layer,
the hard coat layer is provided directly on the polyester base,
the hard coat layer contains a metal oxide, and
the metal oxide is contained in a ratio of 20 vol % to 42 vol %.

2. The antireflection film according to claim 1,
wherein the principal surface of the polyester base on the side on which the antireflection layer is disposed has not been subjected to an adhesion-improving surface pretreatment.

3. The antireflection film according to claim 1,
wherein the antireflection layer is such that no peeling of the antireflection layer from the polyester base is observed in a cross cut test performed based on JIS K 5600-56.

4. The antireflection film according to claim 1,
wherein a maximum value of a difference in amplitude of a reflectance of the antireflection film at 380 nm to 780 nm is 1.0% or lower.

5. The antireflection film according to claim 1,
wherein a near infrared ray absorption layer is disposed on a side of the other principal surface of the polyester base.

6. A display front plate, comprising:
a substrate; and
an antireflection film as claimed in any one of claims 1 to 5 that is disposed on the substrate.
